(19) United States
(12) Patent Application Publication
(10) Pub. No.: US 2025/0201932 A1
(43) Pub. Date: Jun. 19, 2025

(54) NON-AQUEOUS ELECTROLYTE SECONDARY BATTERY

(71) Applicant: Panasonic Energy Co., Ltd., Osaka (JP)

(72) Inventor: Yosuke IMANISHI, Nara (JP)

(21) Appl. No.: 18/848,047

(22) PCT Filed: Mar. 23, 2023
(86) PCT No.: PCT/JP2023/011487

§ 371 Date: Sep. 17, 2024

(30) Foreign Application Priority Data
Mar. 29, 2022 (JP) 2022-054258

(51) Int. Cl. H01M 10/0587; H01M 50/595

(52) U.S. Cl. CPC H01M 10/0587; H01M 50/595

(57) ABSTRACT

A non-aqueous electrolyte secondary battery including: a wound electrode assembly obtained by winding together a band-shaped positive electrode plate and a band-shaped negative electrode plate with a separator therebetween; and an outer housing can. A negative or positive electrode core is exposed at the outermost periphery of the assembly, and a portion at least one location on the wound-side end of the outermost peripheral surface is fixed by at least one piece of tape. When a region of the outermost peripheral surface where at least one piece of tape is affixed is a first region, a region thereof where no piece of tape has been affixed is a second region, and a region thereof that overlaps with the second region on the inner wound surface of the outermost peripheral section of the negative electrode plate is a third region, a spacer is provided on a portion of the third region.

### TECHNICAL FIELD

The present disclosure relates to a non-aqueous electrolyte secondary battery.

### BACKGROUND

Recently, a non-aqueous electrolyte secondary battery such as a lithium-ion secondary battery is used as a power source for an electric vehicle (EV) or a large-scale storage facility. In this secondary battery, charging and discharging are repeated, and when heat accumulates in an outer housing can that houses an electrode assembly as a power generation element, durability tends to decrease. In particular, in order to use the lithium-ion battery for an application such as EV, the lithium-ion battery needs to endure use under a severe condition such as rapid charging/discharging. However, it was found that the amount of heat generated in the lithium-ion battery increases during rapid charging/discharging. Accordingly, Patent Literatures 1 and 2 disclose a technique in which heat generated in an outer housing can can be efficiently dissipated.

Specifically, Patent Literature 1 discloses a secondary battery where a wound electrode assembly obtained by winding a positive electrode plate and a negative electrode plate with a separator interposed therebetween is housed in an outer housing can. The secondary battery includes: a single-coated portion that is provided on an outermost peripheral portion of the electrode assembly and where a negative electrode mixture layer of the negative electrode plate is formed on only a single surface; and a non-coated portion that is provided on a winding-end side further than the single-coated portion and where both surfaces of a negative electrode core of the negative electrode plate are exposed, in which the single-coated portion and the negative electrode core exposed surfaces of the non-coated portion are in contact with an outer housing can inner surface.

Patent Literature 2 discloses a secondary battery, in which a single-coated portion where a negative electrode mixture layer of a negative electrode plate is formed on only a single surface is positioned on an outermost peripheral portion of the electrode assembly, and a negative electrode core exposed surface of the single-coated portion opposite to the negative electrode mixture layer is in contact with an outer housing can inner surface.

### CITATION LIST

### Patent Literature

Patent Literature 1: WO2009/144919A
Patent Literature 2: JP2013-254561A

### SUMMARY

Patent Literatures 1 and 2 do not mention a method of fixing the outer peripheral portion of the electrode assembly. In general, in order to maintain the wound structure of the electrode assembly and to smoothly insert the electrode assembly into the outer housing can, an insulating tape is affixed to the outermost peripheral portion of the electrode assembly to fix the winding-end side end to the outermost peripheral portion. However, when the insulating tape is disposed on the outermost peripheral portion of the electrode assembly, contact between the negative electrode core of the outermost peripheral portion and the outer housing can inner surface may be inhibited. As a result, the dissipation efficiency of heat generated from the electrode assembly in the outer housing can decreases, which may lead to a decrease in cycle characteristics during charging/discharging.

An object of the present disclosure is to improve a dissipation efficiency of heat of an electrode assembly in a configuration of a non-aqueous electrolyte secondary battery where an outermost periphery of an electrode assembly is fixed using a tape.

A non-aqueous electrolyte secondary battery according to the present disclosure includes: a wound electrode assembly including a band-shaped positive electrode plate where a positive electrode mixture layer is formed on both surfaces of a positive electrode core, and a band-shaped negative electrode plate where a negative electrode mixture layer is formed on both surfaces of a negative electrode core, in which the positive electrode plate and the negative electrode plate are wound with a separator interposed between the positive electrode plate and the negative electrode plate; and an outer housing can that houses the electrode assembly, in which the negative electrode core or the positive electrode core is exposed on an outermost peripheral surface of the electrode assembly and one or more positions of a winding-end side end portion of the outermost peripheral surface are fixed using one or more tapes, and when a region of the outermost peripheral surface to which the one or more tapes are affixed is set as a first region, a region to which the tape is not affixed is set as a second region, and a region that overlaps the second region on a winding inner surface of an outermost peripheral portion of an electrode plate having the outermost peripheral surface among the negative electrode plate and the positive electrode plate is set as a third region, a spacer is provided on a part of the third region opposite to the second region with the outermost peripheral portion therebetween.

In the non-aqueous electrolyte secondary battery according to the present disclosure, a portion of the outermost peripheral portion of the electrode assembly to which the tape is not affixed can be pushed out by the spacer. As a result, irrespective of the configuration where the outermost periphery of the electrode assembly is fixed using the tape, on the outermost peripheral portion of the electrode assembly, the portion to which the tape is not affixed is likely to be in contact with the outer housing can. Therefore, heat of the electrode assembly is likely to be dissipated through the outer housing can, and thus the dissipation efficiency of the heat of the electrode assembly can be improved.

### BRIEF DESCRIPTION OF DRAWINGS

FIG. 1 is a cross-sectional view taken along an axial direction of a non-aqueous electrolyte secondary battery according to an example of an embodiment.

FIG. 2 is a perspective view illustrating an electrode assembly configuring the non-aqueous electrolyte secondary battery according to the example of the embodiment.

FIG. 3 is a diagram illustrating a winding outer surface of an outermost peripheral portion in a developed view of a negative electrode plate configuring the non-aqueous electrolyte secondary battery according to the example of the embodiment.

FIG. 4 is a diagram illustrating a winding inner surface of the outermost peripheral portion in the developed view of the negative electrode plate of FIG. 3.

FIG. 5 is a cross-sectional view illustrating the vicinity of the outermost peripheral portion of the electrode assembly of FIG. 2.

FIG. 6 is a perspective view illustrating an electrode assembly according to Example 3.

FIG. 7 is a perspective view illustrating an electrode assembly according to Comparative Example 1.

FIG. 8 is a perspective view illustrating an electrode assembly according to Comparative Example 2.

### DESCRIPTION OF EMBODIMENTS

Hereinafter, embodiments according to the present invention will be described in detail with reference to the accompanying drawings. In the following description, specific shapes, materials, numbers, numerical values, directions, and the like are merely examples for easy understanding of the present invention, and can appropriately change depending on the specification of a non-aqueous electrolyte secondary battery. In addition, hereinafter, the term “substantially” is used in senses including not only a case where somethings are completely the same but also a case where somethings are substantially the same. Further, it is assumed from the beginning that, when the following description includes a plurality of embodiments and modification examples, characteristic portions thereof are appropriately combined and used.

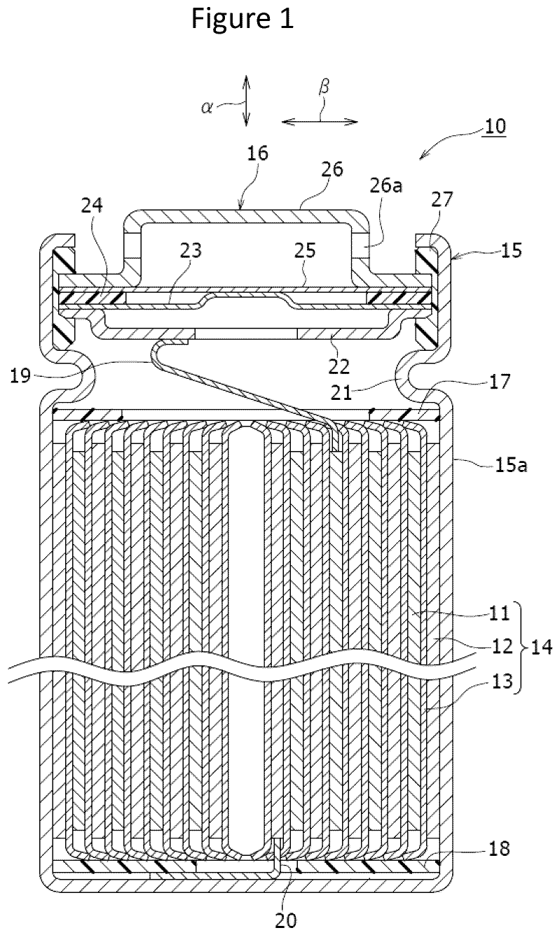

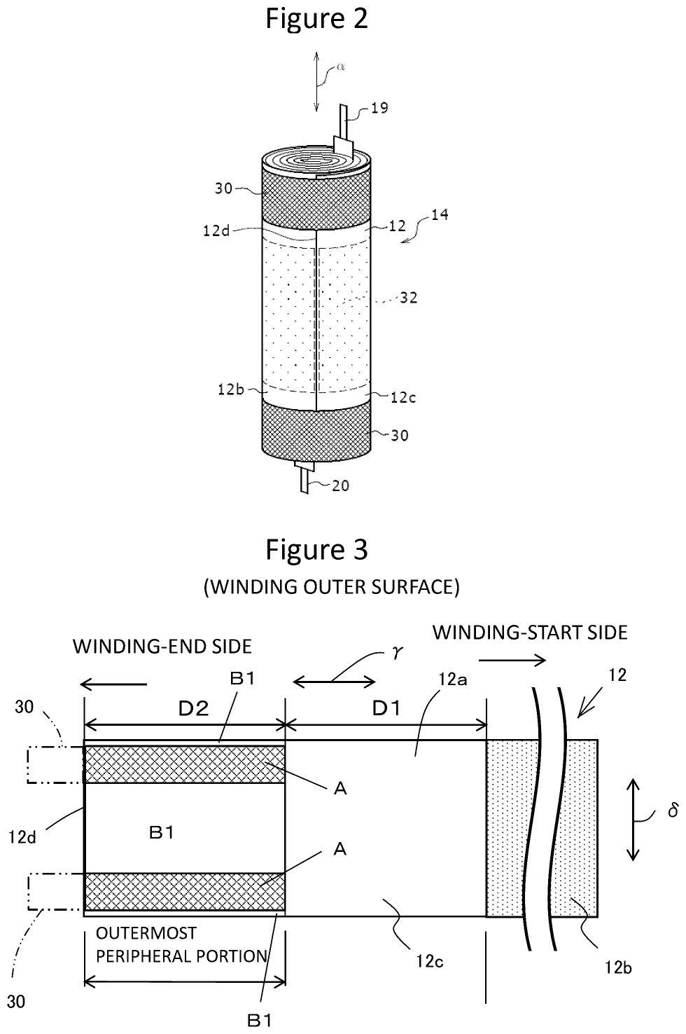

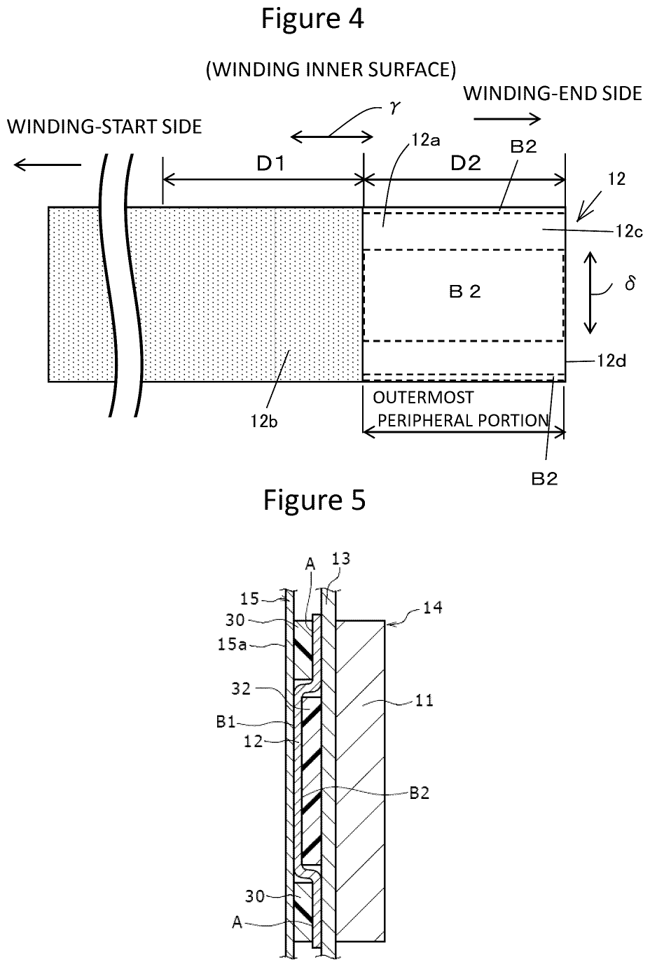

FIG. 1 is a cross-sectional view taken along an axial direction of a non-aqueous electrolyte secondary battery 10 according to an example of an embodiment. FIG. 2 is a perspective view illustrating an electrode assembly 14 configuring the non-aqueous electrolyte secondary battery 10. FIG. 3 is a diagram illustrating a winding outer surface of an outermost peripheral portion in a developed view of a negative electrode plate 12 configuring the non-aqueous electrolyte secondary battery 10, and FIG. 4 is a diagram illustrating a winding inner surface of the outermost peripheral portion in the developed view of the negative electrode plate 12. As illustrated in FIGS. 1 to 4, the non-aqueous electrolyte secondary battery 10 includes the wound electrode assembly 14, a non-aqueous electrolyte (not illustrated), an outer housing can 15, and a sealing assembly 16. The wound electrode assembly 14 includes a positive electrode plate 11, the negative electrode plate 12, and a separator 13, in which the positive electrode plate 11 and the negative electrode plate 12 are spirally wound with the separator 13 interposed therebetween. Hereinafter, one side in the axial direction of the electrode assembly 14 will also be referred to as “upper”, and another side in the axial direction will also be referred to as “lower”. The non-aqueous electrolyte includes a non-aqueous solvent and an electrolyte salt dissolved in the non-aqueous solvent. The non-aqueous electrolyte is not limited to a liquid electrolyte, and may be a solid electrolyte in which a gel polymer or the like is used.

A positive electrode tab 19 that is a conductive member is joined and electrically connected to the positive electrode plate 11. The positive electrode tab 19 is a conductive member for electrically connecting a positive electrode core configuring the positive electrode plate 11 to a positive electrode terminal, and extends from an upper end of the positive electrode core in the electrode assembly 14 toward one side (upper side) in the axial direction a. It is preferable that the positive electrode tab 19 is formed of a metal including aluminum as a major component. In the positive electrode plate 11, a positive electrode mixture layer is formed on each of a winding inner surface (inner surface in a radial direction) and a winding outer surface (outer surface in the radial direction) of the positive electrode core.

As illustrated in FIGS. 3 and 4, the negative electrode plate 12 includes a band-shaped negative electrode core 12a and a negative electrode tab 20 (FIGS. 1 and 2) that is joined to the negative electrode core 12a. The negative electrode tab 20 is a conductive member for electrically connecting the negative electrode core 12a and a bottom portion of the outer housing can 15 described below, and extends from a lower end of the negative electrode core 12a in the electrode assembly 14 toward another side (lower side) in the axial direction a (FIGS. 1 and 2) that matches with an electrode plate width direction 8 of the negative electrode plate 12. The outer housing can 15 is a negative electrode terminal. The negative electrode tab 20 is provided, for example, in an inner wound portion (inner peripheral portion) of the electrode assembly 14. The negative electrode tab 20 may be provided in an outer wound portion (outer peripheral portion) of the electrode assembly 14. The negative electrode tab 20 is a band-shaped conductive member. A constituent material of the negative electrode tab is not particularly limited. It is preferable that the negative electrode tab is formed of a metal including nickel or copper as a major component or is formed of a metal including both of nickel and copper. Further, in the negative electrode plate 12, a negative electrode mixture layer 12b is formed on each of a winding inner surface (inner surface in the radial direction) and a winding outer surface (outer surface in the radial direction) of the negative electrode core 12a.

Further, as illustrated in FIG. 3, in a winding outer surface of a winding-end side end portion of the negative electrode plate 12, the negative electrode mixture layer is not formed on the negative electrode core 12a, and a core exposed surface 12c where the negative electrode core 12a is exposed is formed.

As described above, the electrode assembly 14 has a wound structure where the positive electrode plate 11 and the negative electrode plate 12 are spirally wound with the separator 13 interposed therebetween. All of the positive electrode plate 11, the negative electrode plate 12, and the separator 13 are formed in a band shape, and are spirally wound to be alternately stacked in a radial direction B (FIG. 1) of the electrode assembly 14. In the electrode assembly 14, an electrode plate longitudinal direction y of each of the electrode plates is a winding direction.

Further, as illustrated in FIG. 2, the core exposed surface 12c where the negative electrode core 12a is exposed as described above is disposed on an outermost peripheral surface of the electrode assembly 14. The core exposed surface 12c is in contact with an inner surface of a cylindrical portion 15a (FIG. 1) of the outer housing can 15 to be electrically connected to the outer housing can 15. Due to the electrical connection between the negative electrode plate 12 and the cylindrical portion 15a of the outer housing can 15, higher current collectability can be ensured, and heat of the electrode assembly 14 can be transferred to the outer housing can 15 to improve heat dissipation performance.

On the other hand, the winding-end side end portion of the outermost periphery of the electrode assembly 14 is fixed using two fixing tapes 30. Specifically, on the winding outer surface of the winding-end side end portion positioned in the outermost peripheral portion of the negative electrode core 12a illustrated in FIG. 3, the two fixing tapes 30 are affixed along the electrode plate longitudinal direction y at positions indicated by hatched portions of both end portions in the electrode plate width direction 8. Each of the fixing tapes 30 is an adhesive tape where an adhesive layer is provided on a single surface of a base layer. In a state where the electrode assembly 14 is formed as illustrated in FIG. 2, a part of each of the fixing tapes 30 is affixed to a part of the hatched portion of FIG. 3 in the longitudinal direction y including a winding-end side end 12d of the negative electrode plate 12, and the remaining part of each of the fixing tapes 30 is affixed to cross the winding-end side end 12d in the winding direction and to be wound around the remaining part of the hatched portion of FIG. 3. Therefore, as illustrated in FIG. 2, the winding-end side end of the electrode assembly 14 is fixed to the outermost peripheral surface of the electrode assembly 14 by each of the fixing tapes 30. In FIG. 2, each of the fixing tapes 30 is indicated by hatching.

This way, the fixing tape 30 is provided on a part of the outermost peripheral surface of the electrode assembly 14. Therefore, due to the thickness of the fixing tape 30, there is a step difference between the affixed portion of the fixing tape 30 provided on the outermost periphery of the electrode assembly and the non-affixed portion of the fixing tape. Therefore, although the core exposed surface 12c is positioned on the outermost peripheral surface of the electrode assembly 14, the contact between the core exposed surface 12c and the outer housing can 15 may be inhibited by the fixing tape 30. In the present embodiment, in order to resolve this inconvenience, a spacer 32 (FIG. 5) is provided on the winding inner surface of the outermost peripheral portion of the negative electrode plate 12 as described below in detail. In FIG. 2, the portion of the inner wound side of the negative electrode plate 12 where the spacer 32 is provided is indicated by a sandy portion.

In the example illustrated in FIG. 1, a metal battery case that houses the electrode assembly 14 and the non-aqueous electrolyte is configured by the outer housing can 15 and the sealing assembly 16. Insulating plates 17 and 18 are provided above and below the electrode assembly 14, respectively. The positive electrode tab 19 extends toward the sealing assembly 16 through a through hole of the upper insulating plate 17 and is welded to a lower surface of a filter 22 that is a bottom plate of the sealing assembly 16. In the non-aqueous electrolyte secondary battery 10, a cap 26 that is a top plate of the sealing assembly 16 electrically connected to the filter 22 serves as a positive electrode terminal.

The outer housing can 15 has a bottomed columnar shape including an opening, and for example, is a bottomed cylindrical metal container. A gasket 27 is provided between the outer housing can 15 and the sealing assembly 16 to ensure sealability inside the outer housing can 15. The outer housing can 15 includes a groove portion 21 that is formed, for example, by spinning a side surface portion from the outer side toward the inner side in the radial direction. The groove portion 21 is preferably formed in an annular shape along the circumferential direction of the outer housing can 15, and supports the sealing assembly 16 on an upper surface thereof. The sealing assembly 16 seals the opening of the outer housing can 15.

The sealing assembly 16 includes the filter 22, a lower valve member 23, an insulating member 24, an upper valve member 25, and the cap 26 that are stacked in order from the electrode assembly 14 side. Each of the members configuring the sealing assembly 16 has, for example, a disk shape or a ring shape, and the members excluding the insulating member 24 are electrically connected to each other. The lower valve member 23 and the upper valve member 25 are connected to each other at central portions thereof, and the insulating member 24 is interposed between peripheral edge portions of the lower valve member 23 and the upper valve member 25. When an internal pressure of the battery increases due to abnormal heat generation, for example, the lower valve member 23 is broken. As a result, the upper valve member 25 swells to the cap 26 side to be spaced apart from the lower valve member 23 such that electrical connection therebetween is interrupted. When the internal pressure further increases, the upper valve member 25 is broken, and gas is discharged from an opening 26a of the cap 26.

The components of the electrode assembly 14 and the spacer 32 provided on the winding inner surface of the outermost peripheral portion of the electrode assembly 14 will be described in detail. The positive electrode plate 11 includes a band-shaped positive electrode core and a positive electrode mixture layer formed on both surfaces of the positive electrode core. As the positive electrode core, for example, foil of a metal such as aluminum or a film where the metal is disposed on the surface layer is used. The preferred positive electrode core is foil of a metal including aluminum or an aluminum alloy as a major component. The thickness of the positive electrode core is, for example, greater than or equal to 10 μm and less than or equal to 30 μm.

It is preferable that the positive electrode mixture layer includes a positive electrode active material, a conductive agent, and a binder. The positive electrode plate 11 is prepared by applying a positive electrode mixture slurry including the positive electrode active material, the conductive agent, the binder, and a solvent such as N-methyl-2-pyrrolidone (NMP) to both surfaces of the positive electrode core and drying and compressing the positive electrode mixture slurry.

Examples of the positive electrode active material include lithium-containing transition metal oxides containing a transition metal element such as Co, Mn, or Ni. The lithium-containing transition metal oxide is not particularly limited and is preferably a composite oxide represented by Formula Li₁₊ₓMO₂ (in the formula, −0.2<x≤0.2, M includes at least one of Ni, Co, Mn and Al).

Examples of the conductive agent include carbon materials including carbon black (CB) such as acetylene black (AB) or Ketjenblack, graphite, and the like. Examples of the binder include a fluorine-based resin such as polytetrafluoroethylene (PTFE) or polyvinylidene fluoride (PVdF), polyacrylonitrile (PAN), polyimide (PI), an acrylic-based resin, and a polyolefin-based resin. In addition, these resins may be used in combination with carboxymethyl cellulose (CMC) or a salt thereof, polyethylene oxide (PEO), or the like. These resins may be used alone or in combination of two or more kinds thereof.

On a part of the positive electrode plate 11 in the electrode plate longitudinal direction, an exposed surface where a surface of a metal configuring the positive electrode core is exposed is formed. The exposed surface is a portion connected to the positive electrode tab 19 and is a portion where the surface of the positive electrode core is not covered with the positive electrode mixture layer.

The negative electrode plate 12 includes the band-shaped negative electrode core 12a and the negative electrode mixture layer 12b that is formed on both surfaces of the negative electrode core 12a. As the negative electrode core 12a, for example, foil of a metal such as copper or a film where the metal is disposed on the surface layer is used. The thickness of the negative electrode core 12a is, for example, greater than or equal to 5 μm and less than or equal to 30 μm.

It is preferable that the negative electrode mixture layer 12b includes a negative electrode active material and a binder. The negative electrode plate 12 is prepared, for example, by applying a negative electrode mixture slurry including the negative electrode active material, the binder, and water to both surfaces of the negative electrode core 12a and drying and compressing the negative electrode mixture slurry.

The negative electrode active material is not particularly limited as long as capable of reversibly storing and releasing lithium ions. For example, a carbon material such as natural graphite or artificial graphite, a metal such as Si or Sn for forming an alloy with lithium, or an alloy or a composite oxide including the metal can be used. As the binder included in the negative electrode active material layer, for example, the same resins as those of the positive electrode plate 11 are used. When the negative electrode mixture slurry is prepared using an aqueous solvent, styrene-butadiene rubber (SBR), CMC or a salt thereof, polyacrylic acid or a salt thereof, polyvinyl alcohol, or the like can be used. These resins may be used alone or in combination of two or more kinds thereof.

In the winding-end side end portion in the electrode plate longitudinal direction y of the negative electrode plate 12, a one side-coated portion where the negative electrode mixture layer 12b is formed only on the winding inner surface and a non-coated portion that is provided on the winding-end side further than the one side-coated portion and where both surfaces of the negative electrode core 12a are exposed are formed. In FIGS. 3 and 4, the one side-coated portion is formed in a range indicated by an arrow D1, and the non-coated portion is formed in a range indicated by an arrow D2 that matches with the outermost peripheral portion. As a result, the core exposed surface 12c where the surface of the metal configuring the negative electrode core 12a is exposed is formed on the negative electrode plate 12.

In addition, although not illustrated in the drawings, a core exposed surface is formed also on a winding-start side end portion of the negative electrode plate 12, and the negative electrode tab 20 is joined to the core exposed surface. The negative electrode tab 20 is welded to an inner surface of the bottom portion of the outer housing can 15 through a through hole of the lower insulating plate 18.

As the separator 13, a porous sheet having ion permeability and insulating properties is used. Specific examples of the porous sheet include microporous membranes, woven fabrics, nonwoven fabrics, and the like. As a material of the separator 13, an olefin-based resin such as polyethylene or polypropylene is preferable. The thickness of the separator 13 is, for example, greater than or equal to 10 μm and less than or equal to 50 μm. The separator 13 tends to be thinned along with an increase in capacity and output of the battery. The separator 13 has a melting point of, for example, about higher than or equal to 130° C. and lower than or equal to 180° C.

To the outermost peripheral surfaces of both end portions in the axial direction of the negative electrode core 12a of the negative electrode plate 12 that are the outermost peripheral surfaces of the electrode assembly 14, the two fixing tapes 30 are affixed to fix the winding-end side end 12d of the negative electrode plate 12. The fixing tapes 30 are formed of the same material and have the same thickness, width, and length. The fixing tapes may have different widths and lengths.

The fixing tape 30 is, for example, a PP tape where an adhesive layer is formed on one surface of a polypropylene (PP) base layer. As the base layer of the fixing tape 30, polyethylene (PE), polyimide (PI), polyethylene terephthalate (PET), or the like can also be used.

On the outermost peripheral surface of the electrode assembly 14, a portion indicated by hatching in FIG. 3 that is a region to which the two fixing tapes 30 are affixed is set as a first region A, a region to which the fixing tape 30 is not affixed is set as a second region B1, and a region that overlaps the second region B1 on the winding inner surface of the outermost peripheral portion of the negative electrode plate 12 is set as a third region B2. The spacer 32 (FIG. 2) is provided in a part of the third region B2.

As illustrated in FIG. 3, on the winding outer surface of the outermost peripheral portion of the negative electrode plate 12, the fixing tapes 30 are affixed with clearances from both ends in the electrode plate width direction 8, respectively. Therefore, on the winding outer surface, the second region B1 is provided in three portions including: two portions between the ends in the electrode plate width direction 8 and the ends outside the affixed portions of the fixing tapes 30 in the electrode plate width direction 8; and one portion between the affixed portions of the two fixing tapes 30. The spacer 32 is provided to be affixed to a part of the center third region among three third regions B2 corresponding to the three second regions B1 on the winding inner surface of the outermost peripheral portion of the negative electrode plate 12 illustrated in FIG. 4. The negative electrode plate 12 is an electrode plate having the outermost peripheral surface of the electrode assembly 14 among the negative electrode plate 12 and the positive electrode plate 11.

FIG. 5 is a cross-sectional view illustrating the vicinity of the outermost peripheral portion of the electrode assembly 14. The spacer 32 is an elastic material and is a tape that is the same as the fixing tape 30. For example, when the fixing tape 30 is a PP tape, the spacer 32 is also formed of a PP tape. The spacer is a preferably a resin tape where an adhesive layer is formed on one surface of a base layer. As the base layer, polyethylene (PE), polyimide (PI), polyethylene terephthalate (PET), or the like can also be used as in the fixing tape 30.

The spacer 32 is affixed along the electrode plate longitudinal direction y to a part of the third region B2 at the center of the winding inner surface of the outermost peripheral portion of the negative electrode plate 12. At this time, the spacer 32 does not protrude from both ends in the electrode plate longitudinal direction y of the third region B2. Due to the presence of the spacer 32, in a state where the electrode assembly 14 is formed, a portion corresponding to the second region B1 of the negative electrode plate 12 interposed between the two fixing tapes 30 can be pushed outside to approach the inner surface of the cylindrical portion 15a of the outer housing can 15 as illustrated in FIG. 5.

It is preferable that the spacer 32 is provided at a position where the distances from both ends in the electrode plate width direction 8 are the same in the center third region B2. In addition, in the center third region B2 where the spacer 32 is positioned, an area ratio of a portion in contact with the spacer 32 is preferably greater than or equal to 50% and more preferably greater than or equal to 80%. In addition, the thickness of the spacer 32 is preferably greater than or equal to 50% and less than or equal to 150% with respect to the thickness of the fixing tape 30.

In the above-described non-aqueous electrolyte secondary battery 10, a portion of the outermost peripheral portion of the electrode assembly 14 to which the fixing tape 30 is not affixed can be pushed out by the spacer 32. As a result, irrespective of the configuration where the outermost periphery of the electrode assembly 14 is fixed using the fixing tapes 30, on the outermost peripheral portion of the electrode assembly 14, the portion to which the fixing tape 30 is not affixed is likely to be in contact with the outer housing can 15. Therefore, heat of the electrode assembly 14 is likely to be dissipated through the outer housing can 15, and thus the dissipation efficiency of the heat of the electrode assembly 14 can be improved. Accordingly, since the outermost periphery of the electrode assembly 14 is fixed using the fixing tapes 30, not only the wound structure of the electrode assembly 14 can be maintained, the productivity during the insertion of the electrode assembly 14 into the outer housing can 15 can be improved, but also favorable contact between the electrode assembly 14 and the inner surface of the outer housing can 15 can be improved. Further, the dissipation efficiency of heat generated in the outer housing can 15 can be improved, and thus the cycle retention rate during charging/discharging can be improved.

### EXAMPLES

The inventors of the present disclosure prepared five secondary batteries in total according to Examples 1 to 3 and Comparative Examples 1 and 2, performed charging/discharging under predetermined conditions, and compared discharge end temperatures substantially matching with discharge maximum temperatures of the secondary batteries to each other to verify the effects of the embodiment.

### Example 1

### [Preparation of Positive Electrode Plate]

As a positive electrode active material, aluminum-containing lithium nickel cobalt oxide represented by LiNi_{0.88}Co_{0.09} Al_{0.0302} was used. Next, 100 parts by mass of LiNi_{0.88}Co_{0.09}Al_{0.03}O₂, 1.0 parts by mass of acetylene black, and 0.9 parts by mass of polyvinylidene fluoride (PVDF) (binder) were mixed in a solvent of N-methyl-2-pyrrolidone (NMP) to prepare a positive electrode mixture slurry. Next, the positive electrode mixture slurry was uniformly applied to both surfaces of an elongated positive electrode core formed of aluminum foil having a thickness of 15 μm, was dried using a drying machine at a temperature of higher than or equal to 100° C. and lower than or equal to 150° C., and removed NMP. Next, the positive electrode mixture slurry that was applied to both surfaces of the positive electrode core and dried was compressed using a roll press machine. Further, the compressed stack where the positive electrode mixture layer was formed on both surfaces of the positive electrode core was cut into a predetermined electrode size to prepare the positive electrode plate 11. At this time, regarding the positive electrode plate 11, the thickness was 0.144 mm, the width was 62.6 mm, and the length was 861 mm. In one end portion of the positive electrode plate 11 in the longitudinal direction, an exposed surface of the core where the mixture layer was not present was formed, and the positive electrode tab 19 formed of aluminum was fixed to the exposed surface by welding.

### [Preparation of Negative Electrode Plate]

As a negative electrode active material, 95 parts by mass of graphite powder and 5 parts by mass of silicon oxide were mixed and used. 100 parts by mass of the negative electrode active material, 1 part by mass of styrene-butadiene rubber (SBR) as a binder, and 1 part by mass of carboxymethyl cellulose (CMC) as a thickener were mixed. This mixture was dispersed in water to prepare a negative electrode mixture slurry. The negative electrode mixture slurry was applied to both surfaces of an elongated negative electrode core formed of copper foil having a thickness of 8 μm, was dried using a drying machine, and was compressed to adjust the thickness of the negative electrode mixture layer using a roller of a roll press machine such that the thickness of the negative electrode was 0.160 mm. The elongated negative electrode core where the negative electrode mixture layer was formed was cut into a predetermined electrode size to prepare the negative electrode plate 12 where the negative electrode mixture layer was formed on both surfaces of the negative electrode core. At this time, regarding the negative electrode plate 12, the width was 64 mm, and the length was 959 mm. In one end portion of the negative electrode plate 12 in the longitudinal direction that was positioned on the winding-start side of the electrode assembly 14, the mixture layer was not present, a core exposed surface where the core surface was exposed was provided, and the negative electrode tab 20 formed of nickel was fixed and attached to the core exposed surface by welding. In addition, in another end portion of the negative electrode plate 12 in the longitudinal direction that was positioned in the outermost peripheral portion of the electrode assembly 14, the mixture layer was not present on both surfaces, a core exposed surface where the core surface was exposed was formed, and the spacer 32 formed of a polypropylene (PP) tape was affixed to the third region B2 (FIG. 4) of the core exposed surface on the winding inner surface. As a result, the negative electrode plate 12 was prepared. At this time, regarding the spacer 32, the width was 48 mm, the thickness was 30 μm, and the length was 62 mm. In addition, as shown in the field “spacer area ratio to third region” of Table 1, the contact area ratio of the spacer 32 to the center third region B2 was 80%.

TABLE 1

| | Fixing Tape | | | | | |
|---|---|---|---|---|---|---|
| | | Number | Spacer | | Spacer Area Ratio | Discharge End |
| | Width | of Tapes | Kind | Thickness | to Third Region | Temperature |
| Example 1 | 9 mm | 2 | PP Tape | 30 μm | 80% | 40° C. |
| Example 2 | 9 mm | 2 | PP Tape | 15 μm | 80% | 41° C. |
| Example 3 | 9 mm | 2 | PP Tape | 30 μm | 50% | 41° C. |
| Comparative | 9 mm | 2 | — | | — | 43° C. |
| Example 1 | | | | | | |
| Comparative | 64 mm | 1 | — | | — | 50° C. |
| Example 2 | | | | | | |

### [Preparation of Electrode Assembly]

The prepared positive electrode plate 11 and the prepared negative electrode plate 12 were spirally wound with the separator 13 formed of polyethylene interposed therebetween, the fixing tape 30 formed of polypropylene (PP) having a width of 9 mm, a thickness of 30 μm, and a length of 62 mm was affixed to the two first regions A on the core exposed surface of the outermost peripheral portion, and the winding-end side end of the outermost peripheral portion was fixed using the fixing tapes 30. As a result, the electrode assembly 14 illustrated in FIG. 2 was prepared. At this time, on the outermost peripheral surface of the electrode assembly 14, the core exposed surface was disposed over the entire periphery in the portions other than the affixed portions of the fixing tapes 30.

### [Preparation of Non-Aqueous Electrolyte]

5 parts by mass of vinylene carbonate (VC) was added to 100 parts by mass of a mixed solvent where ethylene carbonate (EC) and dimethyl carbonate (DMC) were mixed at a volume ratio of EC:DMC=1:3, and LiPF₆ was dissolved such that the amount thereof 1.5 mol/L. As a result, a non-aqueous electrolyte was prepared.

### [Preparation of Secondary Battery]

The above-described electrode assembly 14 was housed in the bottomed cylindrical outer housing can 15, the insulating plates 17 and 18 were disposed above and below the electrode assembly 14, the negative electrode tab was welded to the bottom portion of the outer housing can 15, the positive electrode tab was welded to the sealing assembly 16, and the electrode assembly 14 was housed in the outer housing can 15. Next, the non-aqueous electrolyte was injected into the outer housing can 15 through a decompression method, and subsequently the sealing assembly 16 was fixed to an opening end portion of the outer housing can 15 by caulking through the gasket 27. As a result, the cylindrical non-aqueous electrolyte secondary battery 10 was prepared. At this time, the capacity of the battery was 4600 mAh.

### Example 2

In Example 2, the thickness of the spacer 32 formed of PP affixed to the third region B2 was 15 μm, which was half the thickness of Example 1. In Example 2, the other configurations are the same as those of Example 1.

### Example 3

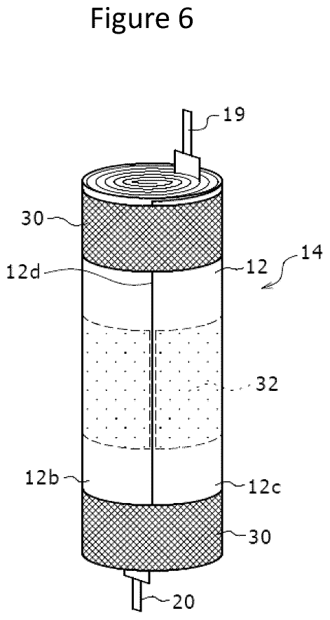

In Example 3, as in the electrode assembly 14 illustrated in FIG. 6, the width of the spacer 32 formed of PP affixed to the third region B2 was 30 mm, which was less than the width of Example 1. As a result, as shown in the field “spacer area ratio to third region” of Table 1, the contact area ratio of the spacer 32 to the center third region B2 was 50%. In Example 3, the other configurations are the same as those of Example 1.

### Comparative Example 1

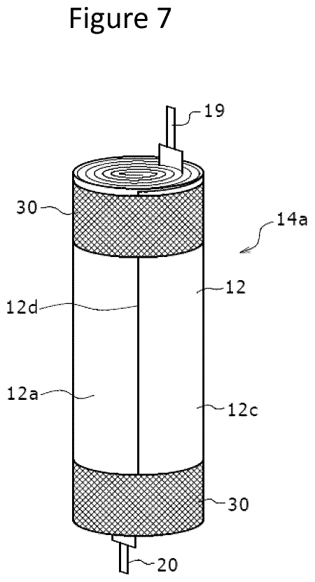

In Comparative Example 1, the spacer was not provided in the third region B2 as in an electrode assembly 14a illustrated in FIG. 7. In Comparative Example 1, the other configurations are the same as those of Example 1.

### Comparative Example 2

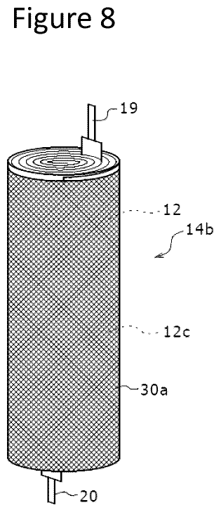

In Comparative Example 2, as in an electrode assembly 14b illustrated in FIG. 8, a fixing tape 30a formed of PP having a width of 64 mm was affixed to the entire outer surface of the core exposed surface of the outermost peripheral portion, and the second region B1 and the third region B2 (FIG. 2) that were provided in Example 1 were not provided. In Comparative Example 2, the other configurations are the same as those of Example 1.

### [Test Method]

In order to evaluate heat dissipation to the outside of the outer housing can 15 affecting cycle characteristics, the discharge end temperatures substantially matching with the discharge maximum temperatures were compared to each other using the non-aqueous electrolyte secondary batteries according to Examples 1 to 3 and Comparative Examples 1 and 2. In the test, in an environment of 25° C., the prepared secondary battery was charged at a constant current of 1380 mA (0.3 It) until a battery voltage reached 4.2 V, and subsequently was charged at a constant voltage until a current value at the battery voltage of 4.2 V reached 92 mA. Further, after a rest for 20 minutes, the secondary battery was discharged at a constant discharge current of 4600 mA (1.0 It), and the temperature of the secondary battery after the discharge end was measured by a thermocouple attached to the surface of the outer housing can 15. Heat was generated from the electrode assembly of the secondary battery during discharging, and the temperature increased until the discharge end. Therefore, by measuring the temperature at the discharge end, the temperature substantially matching with the maximum temperature of the secondary battery during discharging was able to be obtained.

### [Test Result]

In the field “discharge end temperature” of Table 1, the temperature measurement result of each of the secondary batteries is shown. As shown in Table 1, it was able to be verified that, in Examples 1 to 3, the discharge end temperatures were able to be set to be lower than those of Comparative Examples 1 and 2. In addition, in Comparative Example 2, the discharge end temperature was quite high. The reason for this is presumed to be that, in Comparative Example 2, the entire outermost peripheral surface of the electrode assembly 14b (FIG. 8) was covered with the fixing tape 30a, and heat transfer from the electrode assembly 14b to the outer housing can 15 was inhibited by the fixing tape 30a. In addition, in Comparative Example 1, the discharge end temperature was decreased to be lower than that of Comparative Example 2, but the decrease was insufficient as compared to those of Examples 1 to 3. The reason for this is presumed to be that, in Comparative Example 1, the contact between the core exposed surface 12c of the outermost peripheral portion of the electrode assembly 14a and the inner surface of the outer housing can 15 was inhibited by the step difference between the affixed portion of the fixing tape 30 provided on the outermost periphery of the electrode assembly 14a (FIG. 7) and the non-affixed portion of the fixing tape. On the other hand, in Examples 1 to 3, the spacer 32 was provided in the third region B2 of the winding inner surface of the outermost peripheral portion of the electrode assembly 14 (FIGS. 2 and 6). As a result, the contact between the core exposed surface 12c of the outermost peripheral portion of the electrode assembly 14 and the inner surface of the outer housing can 15 was improved, and thus a temperature increase caused by heat generation was able to be suppressed by heat dissipation through the outer housing can 15. Therefore, it is considered that the discharge end temperature decreased.

In Example 2, the discharge end temperature was higher than that of Example 1. The reason for this is presumed to be that the thickness of the spacer 32 affixed to the third region B2 was small and the contact between the core exposed surface 12c of the outermost peripheral portion of the electrode assembly 14 and the inner surface of the outer housing can 15 was insufficient as compared to that of Example 1.

In Example 3, the discharge end temperature was higher than that of Example 1. The reason for this is presumed to be that the contact area ratio of the spacer 32 to the third region B2 was small and the contact between the core exposed surface 12c of the outermost peripheral portion of the electrode assembly 14 and the inner surface of the outer housing can 15 was insufficient as compared to Example 1.

In the above-described embodiment, the case where the spacer 32 is an adhesive tape has been described. However, the spacer may be an elastomer such as a resin not including an adhesive layer. On the other hand, when the spacer is an adhesive tape, the spacer can be easily provided by being affixed to the winding inner surface of the outermost peripheral portion of the negative electrode plate. Therefore, the spacer is preferably an adhesive tape from the viewpoint of improving the productivity of the secondary battery.

In addition, in the above-described embodiment, one or more positions of the winding-end side end portion of the outermost peripheral surface of the electrode assembly only need to be fixed using one or more tapes. Therefore, only one position of the winding-end side end portion of the outermost peripheral surface of the electrode assembly may be fixed using one fixing tape. In this case, on the outermost peripheral surface of the electrode assembly, a region to which one fixing tape is affixed is the first region, and a region to which the fixing tape is not affixed is the second region. The spacer is provided in a part of the third region that overlaps the second region on the winding inner surface of the outermost peripheral portion of the negative electrode plate having the outermost peripheral surface.

In addition, in the above-described embodiment, the case where the fixing tape 30 is provided along the winding direction that matches with the electrode plate longitudinal direction of the electrode assembly has been described. However, the configuration of the present disclosure is not particularly limited, and a configuration where the fixing tape is disposed along the axial direction matching with the electrode plate width direction to fix the winding-end side end of the electrode assembly to the outermost peripheral surface may be adopted. Even in this case, on the winding inner surface of the outermost peripheral portion of the negative electrode plate, the spacer can be provided in a part of the third region that overlaps the second region other than the first region to which the fixing tape of the winding outer surface is affixed.

In addition, in the above-described embodiment, the case where the core exposed surface 12c of the negative electrode plate 12 is positioned on the outermost peripheral surface of the electrode assembly 14 and the core exposed surface 12c is in contact with the inner surface of the outer housing can 15 has been described. On the other hand, the configuration of the present disclosure is not limited to this example, and a configuration where the core exposed surface of the positive electrode plate is positioned on the outermost peripheral surface of the electrode assembly and the core exposed surface is in contact with the inner surface of the outer housing can may be adopted. In this case, the outer housing can serves as the positive electrode terminal. In this case, the negative electrode tab connected to the negative electrode plate of the electrode assembly is led out to the sealing assembly and is connected to the sealing assembly, and thus the sealing assembly can serve as the negative electrode terminal.

### REFERENCE SIGNS LIST

10 Non-aqueous electrolyte secondary battery
11 Positive electrode plate
12 Negative electrode plate
12a Negative electrode core
12b Negative electrode mixture layer
12c Core exposed surface
12d Winding-end side end
13 Separator
14, 14a, 14b Electrode assembly
15 Outer housing can
15a Cylindrical portion
16 Scaling assembly
17, 18 Insulating plate
19 Positive electrode tab
20 Negative electrode tab
21 Groove portion
22 Filter
23 Lower valve member
24 Insulating member
25 Upper valve member
26 Cap
26a Opening
27 Gasket
30, 30a Fixing tape
32 Spacer

1. A non-aqueous electrolyte secondary battery comprising:
a wound electrode assembly including
a band-shaped positive electrode plate where a positive electrode mixture layer is formed on both surfaces of a positive electrode core, and
a band-shaped negative electrode plate where a negative electrode mixture layer is formed on both surfaces of a negative electrode core,
in which the positive electrode plate and the negative electrode plate are wound with a separator interposed between the positive electrode plate and the negative electrode plate; and
an outer housing can that houses the electrode assembly,
wherein the negative electrode core or the positive electrode core is exposed on an outermost peripheral surface of the electrode assembly and one or more positions of a winding-end side end portion of the outermost peripheral surface are fixed using one or more tapes, and
when a region of the outermost peripheral surface to which the one or more tapes are affixed is set as a first region, a region to which the tape is not affixed is set as a second region, and a region that overlaps the second region on a winding inner surface of an outermost peripheral portion of an electrode plate having the outermost peripheral surface among the negative electrode plate and the positive electrode plate is set as a third region, a spacer is provided on a part of the third region.

2. The non-aqueous electrolyte secondary battery according to claim 1,
wherein an area ratio of a portion in contact with the spacer in the third region where the spacer is positioned is greater than or equal to 50%.

3. The non-aqueous electrolyte secondary battery according to claim 2,
wherein the area ratio of the portion in contact with the spacer in the third region where the spacer is positioned is greater than or equal to 80%.

4. The non-aqueous electrolyte secondary battery according to claim 1,
wherein a thickness of the spacer is greater than or equal to 50% and less than or equal to 150% with respect to a thickness of the tape.

5. The non-aqueous electrolyte secondary battery according to claim 1,
wherein the spacer is a tape that is the same as the tape.
